(19) United States
(12) Patent Application Publication
(10) Pub. No.: US 2011/0036213 A1
(43) Pub. Date: Feb. 17, 2011

(54) HAND TOOL ASSEMBLY

(76) Inventor: Jeng-Fung HUANG, Taichung City (TW)

Correspondence Address: Hershkovitz & Associates, LLC, 2845 Duke Street, Alexandria, VA, 22314, US

(21) Appl. No.: 12/540,359

(22) Filed: Aug. 12, 2009

(51) Int. Cl. B25B 23/12

(52) U.S. Cl. 81/449; 81/451

(57) ABSTRACT

A hand tool assembly has a body and a resilient magnetic assembly. The body has a connection bar. The resilient magnetic assembly has a resilient element and a magnet. The resilient element is elastic and has a proximal end and a distal end. The proximal end of the resilient element is securely connected with the connection bar. The magnet is mounted securely on the distal end of the resilient element. Therefore, fastening elements can be removed easily and do not interfere with operation of the hand tool assembly.

### BACKGROUND OF THE INVENTION

1. Field of Invention

The present invention relates to a hand tool assembly, and more particular to a hand tool assembly having a magnet connected to a resilient element.

2. Description of the Related Art

With reference to FIGS. 7 and 8, a conventional socket wrench (80) has a connection bar (83), an extension bar (84) and a magnet (85). The extension bar (84) protrudes from the connection bar (83), and the magnet (85) is securely mounted on a free end of the extension bar (84). The conventional socket wrench (80) is convenient to use since the magnet (85) attracts an element such as a nut, screw or the like to facilitate use.

However, the conventional socket wrench (80) is not suitable for all kinds of elements. For instance, the socket wrench (80) is not for use with a screw (92) having a washer (922). The screw (92) with the washer (922) is not able to contact with and be attracted by the magnet (85) since the washer (922) cannot enter a mouth of a socket (91) and comprises a distance with the magnet (85), as shown in FIG. 7. Moreover, removing a nut (93) from the socket (91) is troublesome since the nut (93) is attracted into the socket (91) and another hand tool may be needed to removing the nut (93) from the socket (91) of the socket wrench (80).

The present invention provides a hand tool assembly to obviate or mitigate the shortcomings of the conventional socket wrench.

### SUMMARY OF THE INVENTION

The primary objective of the present invention is to provide a hand tool assembly that has a movable magnet.

The hand tool assembly has a body and a resilient magnetic assembly. The body has a connection bar. The resilient magnetic assembly has a resilient element and a magnet. The resilient element has a proximal end and a distal end. The proximal end of the resilient element is securely mounted with the connection bar. The magnet is mounted securely on the distal end of the resilient element. The connection bar is connected with a socket during use and the magnet is located near a mouth of the socket. The magnet may directly connect to and attract various fastening elements without interfering with a connection between the socket and the fastening element since the magnet is movable in the socket.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a hand tool assembly in accordance of the present invention;

FIG. 2 is a perspective view of a second embodiment of a hand tool assembly in accordance of the present invention;

FIG. 3 is a perspective view of a third embodiment of a hand tool assembly in accordance of the present invention;

FIG. 4A is cross sectional side view of a first embodiment of a connection of the resilient magnetic assembly with the connection bar in FIG. 1;

FIG. 4B is cross sectional side view of a second embodiment of a connection of the resilient magnetic assembly with the connection bar in FIG. 2;

FIG. 5 is a perspective view of a third embodiment of a connection of a resilient magnetic assembly to a connection bar in accordance with the present invention;

FIG. 5A is an enlarged perspective view of the third embodiment of the connection of a resilient magnetic assembly to the connection bar in FIG. 5;

FIG. 6 is an operational perspective view in partial section of the hand tool assembly in FIG. 3;

FIG. 7 is a perspective view in partial section of a conventional socket wrench in accordance with the prior art applied to a screw with a washer; and

FIG. 8 is a perspective view in partial section of the conventional socket wrench in FIG. 8 applied to a nut.

### DETAILED DESCRIPTION OF THE INVENTION

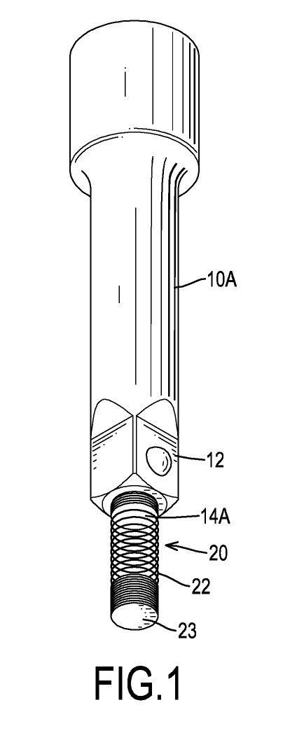

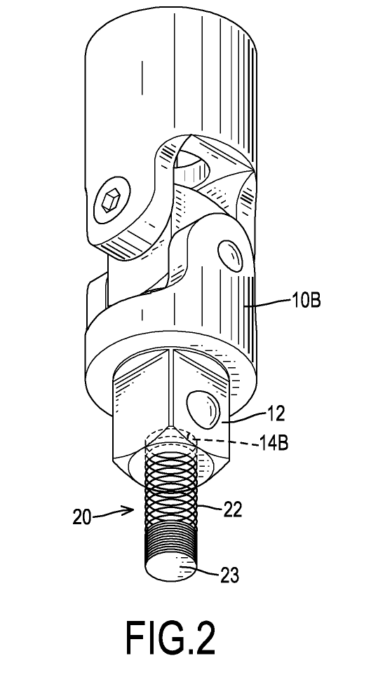

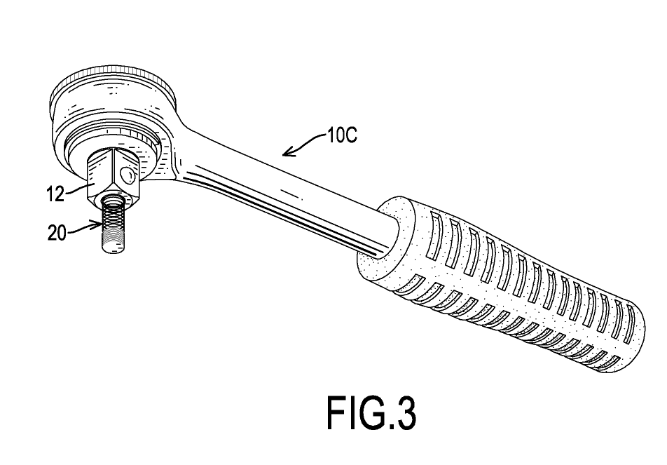

With reference to FIGS. 1, 2 and 3, a hand tool assembly in accordance with the present invention comprises a body (10A, 10B, 10C) and a resilient magnetic assembly (20). The body (10A, 10B, 10C) may be an extension bar (10A), a universal joint (10B) or a wrench (10C). The body (10A, 10B, 10C) has a connection bar (12).

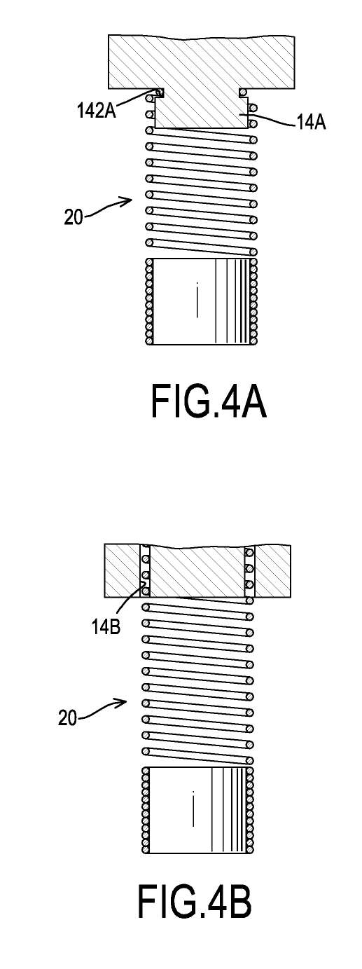

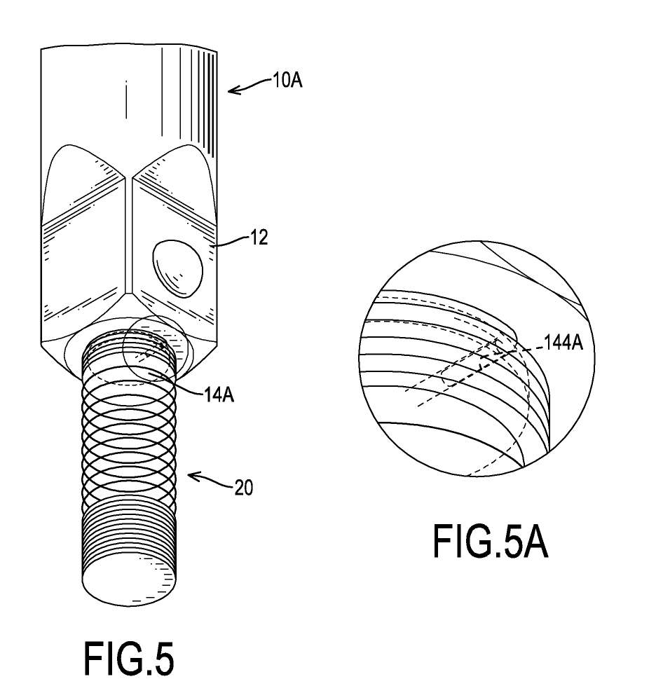

With reference to FIGS. 4A, 4B, 5 and 5A, the connection bar (12) has an end surface and may have a connection cylinder (14A) or an annular recess (14B).

The connection cylinder (14A) protrudes from the end surface of the connection bar (12). The connection cylinder (14A) may have a mounting groove (142A) or a mounting hole (144A) formed in the connection cylinder (14A) adjacent to the end surface of the connection bar (12).

The annular recess (14B) is formed in the end surface of the connection bar (12).

The resilient magnetic assembly (20) has a resilient element (22) and a magnet (23). The resilient element (22) may be a spring, an elastomer or the like and has a proximal end and a distal end. The proximal end of the resilient element (22) is securely connected with the connection bar (12). The resilient element (22) is shaped corresponding to the connection cylinder (14A) or the annular recess (14B) so as to be mounted around the connection cylinder (14A) or be mounted in the annular recess (14B). Furthermore, the resilient element (22) is securely connected with the connection cylinder (14A) via the mounting groove (142A) or the mounting hole (144A), that is, a connecting end at the proximal end of the resilient element (22) is mounted in the mounting groove (142A) or the mounting hole (144A) for attachment to the connection cylinder (14A).

The magnet (23) is mounted securely on a distal end of the resilient element (22).

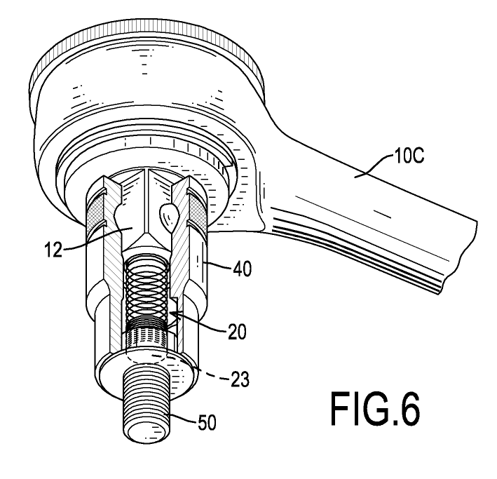

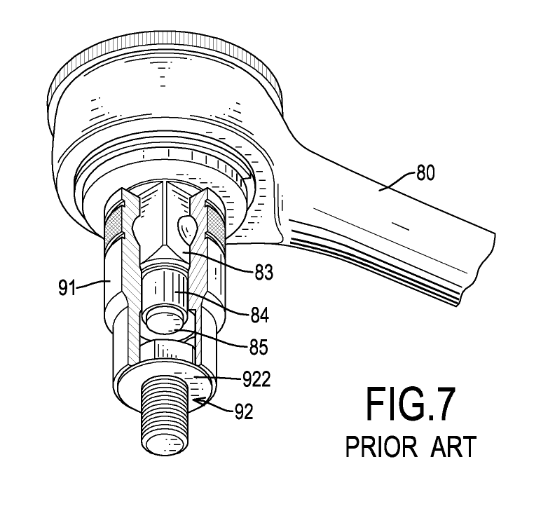

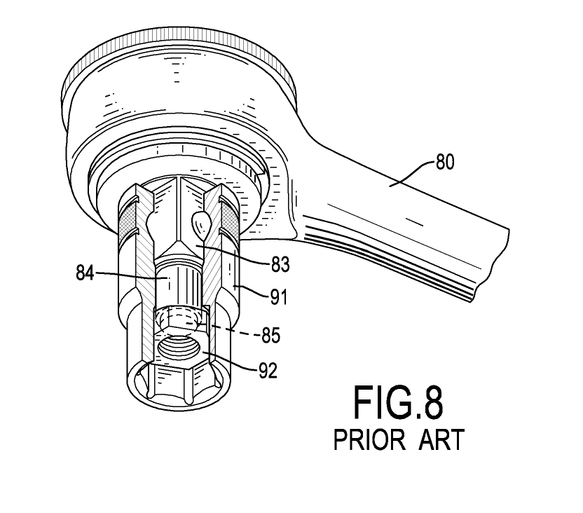

With reference to FIG. 6, the connection bar (12) is connected with a socket (40) and the magnet (23) may be located near a mouth of the socket (40) or may protrude out of a mouth of the socket (40). Because the magnet (23) is extensible and is located near the mouth of the socket (40), the magnet (23) is able to directly contact a fastening element (50) during use. Therefore, a free fastening element (50) will be attracted by the magnet (23) and may be located near or outside the socket (40) so can be removed easily. Furthermore, the magnet (23) does not influence the connection between the socket (40) and the fastening element (50) since the magnet (23) is connected to the resilient element (22), is movable and will be pushed into the socket (40) when the socket (40) is mounts around the fastening element (50).

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A hand tool assembly comprising a body and a resilient magnetic assembly, wherein
the body has a connection bar; and
the resilient magnetic assembly has a resilient element and a magnet, the resilient element has a proximal end and a distal end, the proximal end of the resilient element is securely connected with the connection bar and the magnet is mounted securely on the distal end of the resilient element.

2. The hand tool assembly as claimed in claim 1, wherein the body is an extension bar.

3. The hand tool assembly as claimed in claim 1, wherein the body is a universal joint.

4. The hand tool assembly as claimed in claim 1, wherein the body is a wrench.

5. The hand tool assembly as claimed in claim 4, wherein the connection bar has an end surface and a connection cylinder protruding from the end surface of the connection bar, and the resilient element is a spring having a connection end mounted surround the connection cylinder.

6. The hand tool assembly as claimed in claim 4, wherein the connection bar has an end surface and an annular recess formed in the end surface of the connection bar, and the resilient element is a spring having a connection end mounted in the annular recess.

7. The hand tool assembly as claimed in claim 5, wherein the connection cylinder has a mounting groove formed in the connection cylinder adjacent to the end surface of the connection bar, and the connection end of the spring is securely mounted in the mounting groove.

8. The hand tool assembly as claimed in claim 5, wherein the connection cylinder has a mounting hole formed in the connection cylinder adjacent to the end surface of the connection bar, and the connection end of the spring is securely mounted in the mounting hole.

9. The hand tool assembly as claimed in claim 1, wherein the connection bar has an end surface and a connection cylinder protruding from the end surface of the connection bar, and the resilient element is a spring having a connection end mounted around the connection cylinder.

10. The hand tool assembly as claimed in claim 1, wherein the connection bar has an end surface and an annular recess formed in the end surface of the connection bar, and the resilient element is a spring having a connection end mounted in the annular recess.

11. The hand tool assembly as claimed in claim 9, wherein the connection cylinder has a mounting groove formed in the connection cylinder adjacent to the end surface of the connection bar, and the connection end of the spring is securely mounted in the mounting groove.

12. The hand tool assembly as claimed in claim 9, wherein the connection cylinder has a mounting hole formed in the connection cylinder adjacent to the end surface of the connection bar, and a connection end of the spring is securely mounted in the mounting hole.
